(19) United States
(12) Patent Application Publication
(10) Pub. No.: US 2009/0144289 A1
(43) Pub. Date: Jun. 4, 2009

(54) Service Oriented File System

(76) Inventors: Kurtis Johnson, Tallahassee, FL (US); Robert van Engelen, Tallahassee, FL (US)

Correspondence Address: Kurtis Johnson, 164 Sinclair Rd., Tallahassee, FL, 32312, US

(21) Appl. No.: 12/328,023

(22) Filed: Dec. 4, 2008

Related U.S. Application Data
(60) Provisional application No. 60/992,236, filed on Dec. 4, 2007.

(51) Int. Cl. G06F 17/30

(52) U.S. Cl. 707/10; 707/E17.01; 707/E17.032

(57) ABSTRACT

A computer-aided system and method is disclosed for designing a service-oriented file system, whose intended function is implemented by a virtual file system extended with a service port mechanism. Each service port in the service-oriented file system is associated with a collection of software applications acting as services that operate on the data provided to the service port. The service port mechanism allows for starting, controlling, and terminating software services within the file system by means of file manipulations. Service requests are initiated by moving data into the service port of a service-oriented file system through the creation of a regular file in a directory under the service port. The service port engine then autonomously starts, controls, and terminates an application that processes the data and also stores the processing results into the file for retrieval. An embodiment of the invention may comprise a distributed file system for autonomous remote servicing of service requests by disparate network hosts. Thus, by directly overriding the basic file operations in a (distributed) file system and by changing the file system semantics to include process creation and control, an organized and transparent environment is created for reliable and secure ubiquitous distributed processing.

### FIELD OF THE INVENTION

Embodiments of the invention relate generally to a computerized file system.

### SUMMARY OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention may provide for a service-oriented file system. In particular, the service-oriented file system may be an extension of a file system, according to an example embodiment of the invention. This invention allows for the generation and control of computer processes by means of file operations. For example, service requests may be made in the form of the creation of a file F, and the service results may likewise be saved to the file F, according to an example embodiment of the invention. Accordingly, a service-oriented file system in accordance with an example embodiment of the invention may allow for a file system to support process creation by file creation and process termination by file deletion. Enforcement of the authentication of requestors performing process control operations is enabled by means of file access permission enforcement. In addition, errors, exceptions, and faults generated by processes are passed back to the requester in the form of file write/read errors and associated messages. Thus, the embodiment of the invention provides for an organized and transparent environment that supports drag-and-drop service requests, starting and stopping of named services and applications, and data processing directly within a file system. Existing file systems do not provide a managed and controlled two-way request-response handling mechanism to and from external applications. For example, Plan9 provides a single one-way pipe to send control messages to applications, much like a device driver. Other operating systems provide device access via a file system interface, but the devices are controlled by the kernel.

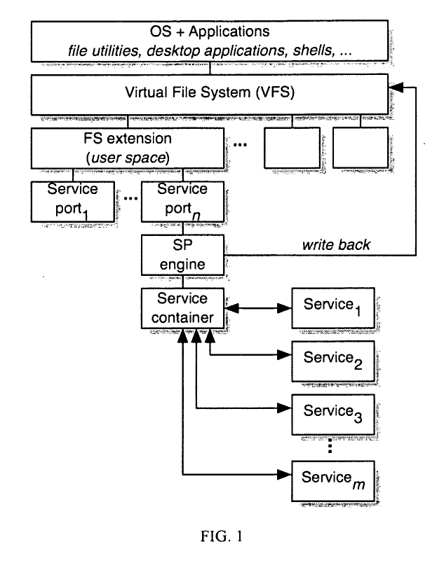

FIG. 1 illustrates a system overview of a service-oriented file system, according to an example embodiment of the invention. As shown in FIG. 1, there is a virtual file system (VFS) that interfaces between file utilities, desktop applications, shells, etc. and a file system extension, according to an example embodiment of the invention. The file system extension may include one or more service ports, which may provide for procedural capabilities, including data processing, for the file system. According to an example embodiment of the invention, a service port may be managed by a service port engine. The service request (e.g., a data processing request) may be received by the service port engine via file manipulation operations such as creation of a file F, and the service port engine may execute or direct execution of the service request and coordinate storage of the service results (e.g., data results) into file F. According to an example embodiment of the invention, the service port engine may direct process the service requests or delegate the processing to another process or application.

According to an example embodiment of the invention, a user or application may initiate a service request by creating a file and/or moving data as a file into a designated service port with the service-oriented file system. The service may then be started as an autonomous process and controlled by the service port engine via an operating system that interfaces the file system. The service port engine executes the data in the file, either directly or indirectly, and upon completion of execution, stores the output data within the same port folder for retrieval by the user or application. According to an example embodiment of the invention, the execution of the data in the file may take the form of executing the data as a script—that is, apply a data transformation process as specified in the script on the data contained in the script/file or otherwise referenced in the script/file. In an alternative embodiment of the invention the data may comprise one or more service operations combined in a protocol format that is specific to the service port. Example protocols may be based on Web services standards for request/response messaging. It will be appreciated that in an embodiment of the invention, a file that is temporarily read-protected until the servicing completes may be replaced with the service results upon completion of the servicing, thereby removing the read protection to allow for retrieval by consumers of the results. However, in alternative embodiments of the invention, the service request may be left intact with the service results being provided according to a different file, and perhaps to a different service port. According to an example embodiment of the invention, the service port that the user or application may interface with may appear in the form of a directory of a folder in the file system. The directory or folder may include files with the data results produced from processing the service requests to completion.

It will be appreciated that the service oriented file system may be implemented according to a distributed file system supported by a network environment, including a distributed network environment that includes a public network, a private network, or a combination thereof. Accordingly, the service-oriented file system may be available to one or more users or applications in one or more locations. These users or applications may be able to provide service requests to the service-oriented file system via one or more service ports. Likewise, the service port engine for a service port may execute or direct execution of the service ports via local processing, remote processing, and/or distributed processing according to example embodiments of the invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

In the following, an email-based usage scenario is described based on an embodiment of the invention. Assumed is the availability of an SMTP email server. A service port for servicing email is added to the embodiment. The service port engine forwards email-send requests to the SMTP server. The usage scenario is as follows. 1) A user composes an email message in a file F and adds an email command to the file content according to the service port's file format conventions. 2) The user copies (e.g. via drag-and-drop) the file F in the service port or uses an email client application to automate this. 3) The service port engine translates the content of F to SMTP and forwards it to the SMTP server. 4a) Upon success, the service port engine stores the file F with the original content. 4b) On failure, the service port engine replaces the content of file F with the error information. 5) The service port engine enables the read-access permissions for F. 6) The user retrieves the status information by reading file F.

In the following, an office document conversion scenario is described based on an embodiment of the invention. Assumed is the availability of a distributed file system accessible by two machines A and B. Furthermore, assumed is the availability of a document-format conversion utility on machine B. A service port for servicing DOC-PDF document conversion is added to the embodiment. The service port physically resides on machine B but is seamlessly accessible on machine A via the distributed file system as if the service port was local. The usage scenario is as follows. 1) A user composes a document of type DOC on machine A. 2) The user copies (e.g. via drag-and-drop) the document file F in the service port. 3) The content of file F is moved by the underlying distributed file system technology to machine B. 3) The service port engine on machine B starts the document conversion process. 4a) Upon success, the service port engine stores the PDF-translated document F. 4b) On failure, the (annotated) original file F is stored. 4c) On cancellation by the user via a deletion command to remove file F, the conversion process is killed and the file F destroyed. 5) The service port engine enables the read-access permissions for F. 6) The user retrieves the converted file F.

In the following, a Web service invocation scenario is described based on an embodiment of the invention. Assumed is the availability of a Web service application that produces responses for requests over HTTP. A service port for servicing the Web service via the file system is added to the embodiment. The service port engine forwards requests to the Web service over HTTP and stores responses in the service port as a file. The usage scenario is as follows. 1) A user composes a service request in file F, containing for example an HTTP GET or a SOAP message, possibly using an interactive desktop utility for automation. 2) The file F is copied to the service port. 3) The service port engine forwards the commands in F to the Web server. 4) The Web server returns the response data or data with an error message. 5) The service port engine stores the data in F. 6) The user retrieves the content of F.

That which is claimed:

1. A service-oriented file system, comprising:
a virtual file system that enables file system extensions;
one or more service ports in communication with the virtual file system, wherein the service ports are operative to receive a file for a service request; and
a service port engine associated with each service port that executes or directs execution of the service request upon receipt of a file and for managing all external access to the files located in a directory structure under the service port.

2. The system of claim 1, wherein upon execution of the service request, the received file is updated with results of the execution of the service request.

3. The system of claim 2, wherein the execution of the service engine and associated processes may be terminated by deletion or flagging of the file that initiated the servicing.

4. The system of claim 2, wherein the file's access permissions are managed by the service engine.

5. The system of claim 4, wherein the change in access permissions indicates completion of the service operations.

6. The system of claim 2, wherein the service port is in communication with the virtual file system via a file system interface or file system extension plugin.

7. The system of claim 1, wherein the service port is accessible as a directory or a folder.

8. The system of claim 1, wherein the service port is remotely accessible via a distributed file system.

9. The system of claim 1, wherein the service port engine is operated by an operating system that interfaces the service-oriented file system.

10. The system of claim 2, wherein the service port engine enforces authentication of requesters through the verification of file creation, read, and write permissions for files located in directories under the service ports.

11. The system of claim 2, wherein the service port engine may deny further write and read operations as a means to pass servicing errors generated by the execution of the service port engine and all associated processes.

12. The system of claim 1, wherein the virtual file system is further in communication with one or more software applications.

13. The system of claim 12, wherein the software applications include file utilities, desktop applications, and shells.

14. The system of claim 1, wherein the service port is operative to receive the file based upon initiation from a user or an application.

15. The system of claim 1, wherein the file includes a command script.

16. The system of claim 15, wherein the command script includes OS-command scripts or web-based command scripts.

17. The system of claim 16, wherein the web-based command scripts are associated with HTTP and/or SOAP/XML web service messaging patterns.

18. The system of claim 15, wherein execution of the file includes processing data included or referenced by file according to the command script.

19. The system of claim 1, wherein the service port is operative to receive the file via one or more communications protocols.

20. The system of claim 19, wherein the communications protocols include FTP.
